(19) United States
(12) Patent Application Publication
(10) Pub. No.: US 2013/0282499 A1
(43) Pub. Date: Oct. 24, 2013

(54) POS TERMINAL

(71) Applicant: TOSHIBA TEC KABUSHIKI KAISHA, (US)

(72) Inventor: Kazunori Kato, Shizuoka-ken (JP)

(21) Appl. No.: 13/850,420

(22) Filed: Mar. 26, 2013

Related U.S. Application Data
(60) Provisional application No. 61/615,988, filed on Mar. 27, 2012.

(51) Int. Cl. G06Q 20/20

(52) U.S. Cl. CPC G06Q 20/20
USPC 705/16

(57) ABSTRACT

In accordance with the present embodiment, a POS terminal comprises a system unit, a battery unit configured to accommodate a plurality of batteries, and a monitoring unit. The monitoring unit is configured to individually monitor the state of each battery accommodated and mounted in the battery unit and notify the state of the battery to the system unit.

### CROSS-REFERENCE TO RELATED APPLICATIONS

This application is based upon and claims the benefit of priority from U.S. Provisional Application No. 61/615,988 filed on Mar. 27, 2012; the entire contents of which are incorporated herein by reference.

### FIELD

Embodiments described herein relate to the technology of the voltage supply of a POS terminal.

### BACKGROUND

Conventionally, as a POS (Point of sale) terminal which can act by a battery did not exist, the POS terminal needed to be activated near an AC power supply. In addition, the POS terminal equipped with a UPS (Uninterruptible Power Supply) with a power failure protection function exists.

For the battery, a high-performance smart battery adopted by a laptop computer becomes a main trend. The smart battery has functions of managing the voltage, the charge and the discharge of the battery and protecting a temperature, an excess current and an excess voltage. The smart battery has a communication function with a mother board, and moreover, notifies an error to the mother board in the condition that the error occurs.

As the smart battery is the high-performance battery, the price is quite high. The POS terminal is used for a long time in day-to-day business, and moreover, the battery is possibly replaced frequently according to a condition. Therefore, if the smart battery is used in the POS terminal, the running expense is spent.

### BRIEF DESCRIPTION OF THE DRAWINGS

FIG. 1 is an external view of a POS terminal of an embodiment;

FIG. 2 is a hardware block diagram of the POS terminal of the embodiment, and is a diagram in which a micro computer is integrated with a main body; and

FIG. 3 is a hardware block diagram of the POS terminal of the embodiment, and is a diagram in which the micro computer is taken as an option unit.

### DETAILED DESCRIPTION

In accordance with an embodiment, a POS terminal comprises a system unit, a battery unit configured to accommodate a plurality of batteries, and a monitoring unit. The monitoring unit is configured to individually monitor the state of each battery accommodated and mounted in the battery unit and notify the state of the battery to the system unit.

In addition, in accordance with the embodiment, the POS terminal comprises the system unit, the battery unit configured to accommodate the battery, and the monitoring unit. The monitoring unit is configured to individually monitor the state of the battery accommodated and mounted in the battery unit, notify the state of the battery to the system unit, and be positioned at the outside of a case of the battery.

In the present embodiment, such a cheap battery pack provided with a fuse with a protection purpose during final error report is used. A POS main body is used for detecting charge, discharge, a battery voltage, a battery temperature, over charge, over discharge, an excess voltage, an excess current and the like. Thus, the low price of the battery is realized, and moreover, the expense spent during running is restrained. In addition, in the present embodiment, a manner in which such a detection apparatus can be detachably mounted to a POS main body unit is also described.

In the condition that a smart battery is adopted, the cost of a mother board is quite low, but the price of the battery as a consumable is quite high. In the present embodiment, the price of the mother board is quite high, but the price of the battery is quite low, and therefore, it is beneficial to an end user frequently replacing the battery.

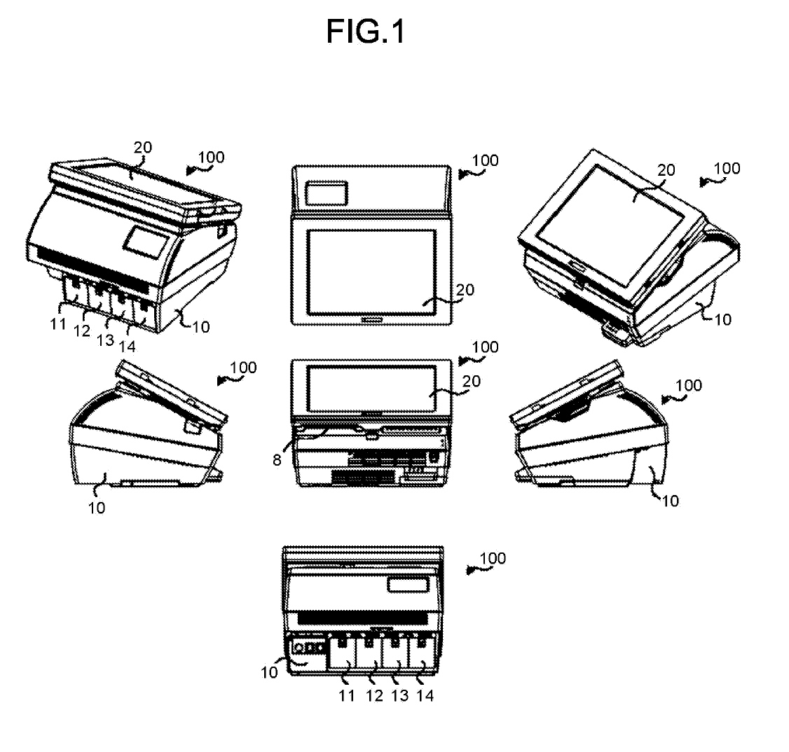

Hereinafter, the present embodiment will be described with reference to the drawings. FIG. 1 is an external view of the POS terminal of the present embodiment. A rear oblique view of the POS terminal 100 is on the left side of an upper portion in FIG. 1, a top view of the POS terminal 100 is in the center of the upper portion in FIG. 1, and a front oblique view of the POS terminal 100 is on the right side of the upper portion in FIG. 1. In addition, a left side view of the POS terminal 100 is on the left side of a middle portion in FIG. 1, a front view of the POS terminal 100 is in the center of the middle portion in FIG. 1, a right side view of the POS terminal 100 is on the right side of the middle portion in FIG. 1, and a back view of the POS terminal 100 is in the center of a lower portion in FIG. 1. The POS terminal 100 comprises the battery unit 10 accommodating four batteries 11, 12, 13 and 14.

The POS terminal 100 comprises a touch panel display 20 displaying information towards a user and operated by the user. An operation surface and a display surface of the touch panel display 20 are upwards oblique at a certain angle in the manner of being suitably identified from an oblique-upper vision.

The POS terminal 100 comprises a printer 8 printing a receipt and the like, and moreover, is configured to be that a discharge port for a sheet is positioned on the front surface of an operator.

The batteries 11-14 are lithium ion batteries detachably mounted to a main body case of the POS terminal 100. The user can replace the battery generating an unfavorable condition or the battery deterioration due to long-time use. For the batteries 11-14, these batteries are extracted from a rear by the user to be disassembled, and are inserted into the battery unit 10 from the rear by the user to be assembled.

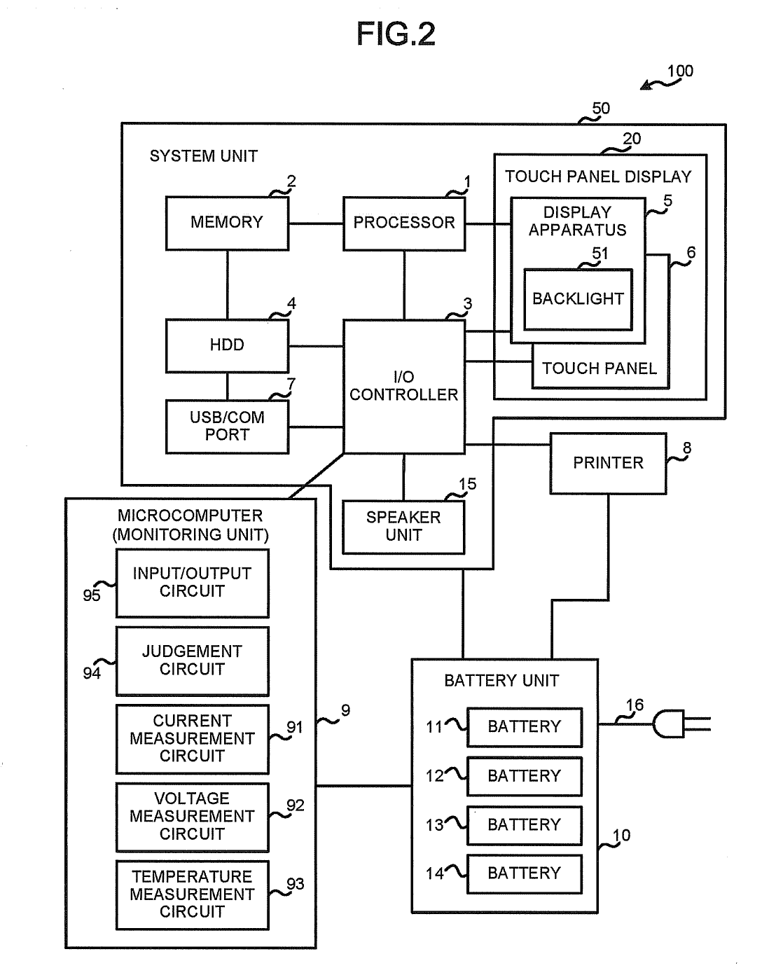

FIG. 2 is a block diagram illustrating a hardware configuration example of the POS terminal 100, thin lines are used for denoting control and signal lines, and thick lines are used for denoting electricity supply lines. The POS terminal 100 comprises the system unit 50, the printer 8 (printer unit), a micro computer 9 (monitoring unit), and the battery unit 10. These units are integrated in one case, and the batteries 11-14 are also integrated by being mounted in one case.

The system unit 50 comprises a processor 1, a memory 2, an I/O (Input Output) controller 3 and an HDD (Hard Disk Drive) 4. In addition, the system unit 50 comprises a USB (Universal Serial Bus)/COM port (communication port) 7, a speaker unit 15 and the touch panel display 20.

The processor 1 takes charge of controlling hardware inside the POS terminal 100, and the processor 1, for example, is a CPU (Central Processing Unit) and an MPU (Micro Processing Unit). The processor 1 develops a program stored in the HDD 4 beforehand in the memory 2 and executes the program. Thus, the processor 1 controls the hardware. The memory 2 is a main storage apparatus carrying out storage in a volatile manner, and the HDD 4 is a magnetic storage apparatus carrying out the storage in a non-volatile manner. The I/O controller 3 is a unit controlling the communication between the units inside the POS terminal 100.

The USB/COM port 7 is a terminal connected with a cable when carrying out the communication with external equipment. The speaker unit 15 gives out the operation voice of the user or a voice when an error is generated, and the like, to an exterior.

The touch panel display 20 comprises a panel type display apparatus 5 and displays the information towards the user by turning on a backlight 51. A touch panel 6 is laminated on the surface of the display apparatus 5. The touch panel 6 detects the press of a fingertip of the user or the press by using a nib of a pen, and outputs coordinate information to the processor 1 through the I/O controller 3.

The printer 8 is a thermal printer printing a character and the like on the sheet and discharging the sheet.

The micro computer 9 is positioned at the outside of the case (battery case) in which the batteries 11-14 are respectively embedded. In the present embodiment, it is formed to be that the micro computer 9 and the processor 1 and the like of the system unit 50 are positioned on the same mother board, and moreover, the electricity supply is also received through a base plate of the mother board. In addition, it can be also formed to be that the system unit 50 and the micro computer 9 are arranged on different boards.

The micro computer 9 individually monitors the states of the batteries 11-14 accommodated and mounted in the battery unit 10 and notifies the states of the batteries 11-14 to the system unit 50. The micro computer 9 individually measures the voltages, the currents and the temperatures of the batteries 11-14, and notifies the error to the processor 1 through the I/O controller 3 in the condition that the error such as the over charge, the over discharge, the excess voltage, the excess current and the like is generated. In the condition that the error is generated, the touch panel display 20 displays the content of the error.

The micro computer 9 comprises a current measurement circuit 91 measuring respective current values of the batteries 11-14. The micro computer 9 comprises a voltage measurement circuit 92 measuring respective voltages of the batteries 11-14. In addition, the micro computer 9 comprises a temperature measurement circuit 93 including a thermistor (sensor) measuring the temperatures of the batteries 11-14.

The micro computer 9 comprises a judgment circuit 94 judging whether or not the batteries 11-14 are in error states of the over charge, the over discharge, the excess voltage and the excess current based on these measured values. The judgment circuit 94 can also detect the residual amount of the batteries 11-14. The micro computer 9 comprises an input/output circuit 95. The input/output circuit 95 receives an inquiry signal through the I/O controller 3 in the condition that the processor 1 gives out the inquiry of a battery state. According to the inquiry signal, the input/output circuit 95 outputs a current temperature, a voltage value and the current value to the processor 1. In the condition that they are in the error states, the input/output circuit 95 outputs the signal to the processor 1 through the I/O controller 3.

In addition, a conventional technology can be adopted for the measurement and the judgment carried out by using the micro computer 9.

The battery unit 10 comprises an opening unit accommodating the batteries 11-14 and comprises the terminal electrically connected with the batteries 11-14. The battery unit 10 can also receive the electricity supply from a commercial power supply through a power supply cable 16 and supply commercial electricity to the system unit 50 and the printer 8. The battery unit 10 is switched to carry out the electricity supply from the batteries 11-14 when the electricity supply from the commercial power supply is cut off.

In addition, the batteries 11-12 are the batteries supplying the electricity to the printer 8, and the batteries 13-14 supply the electricity to the system unit 50, the micro controller 9 and the battery unit 10 except the printer 8. As a limit of the battery, the current has an allowable range, but the current possibly exceeds a rating in the conditions that a load is applied to the system unit 50, and moreover, the printer 8 is used for carrying out high-density printing. Therefore, in the present embodiment, the batteries are divided into the battery supplying the electricity to the system unit 50 and the battery supplying the electricity to the printer 8.

In addition, in the present embodiment, the batteries are set to each two redundant configurations. Thus, even though one of the batteries is taken down to replace the battery, it can be also used by the other battery. In addition, in the condition of a rating range, one battery can be also used for supplying the electricity to each unit in the POS terminal 100.

The smart battery comprises a processor equivalent to the micro controller 9 or a controller inside the battery. In the condition of such a configuration, the smart battery outputs the residual amount value, the temperature value, the charge current value, the discharge current value or the voltage value of the battery to the processor or the controller of the system unit forming a host. In this way, the battery state is monitored by the smart battery itself, the error is detected, and the battery state and the error are notified to the system unit through a system bus.

In the POS terminal 100 in FIG. 2, the micro computer 9 positioned on the side of the main body detects the residual amount value, the temperature value, the charge current value, the discharge current value or the voltage value and the like of the battery, and notifies the residual amount value, the temperature value, the charge current value, the discharge current value or the voltage value and the like of the battery to the processor 1. By the configuration, the processor or the controller is not needed inside the battery, and thus, the structure of the battery can be simplified, and the price can be also reduced. In the condition that the battery degrades, the battery can be replaced with the cheap battery, and therefore, the cost during use can be restrained. In addition, the amount of a waste can be also restrained when the battery is discarded, so that the environmental pollution can be restrained.

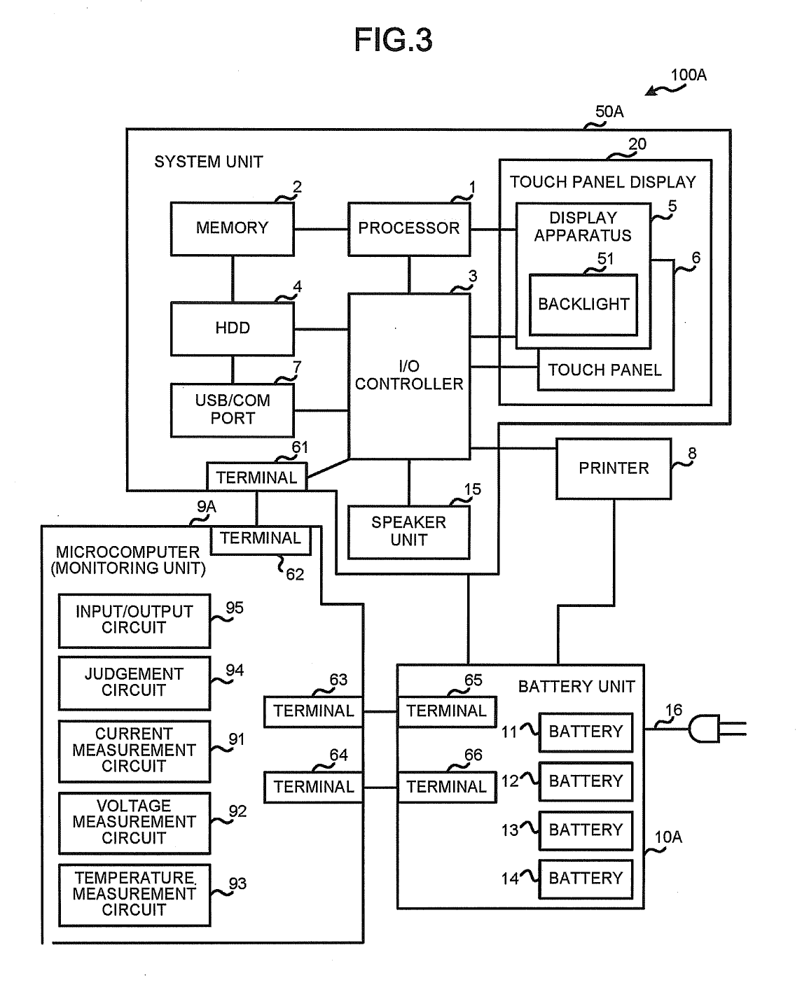

In addition, the micro computer monitoring the battery can be also set as an option unit, and the micro computer can be detachably mounted to the main body unit of the POS terminal. A block diagram in such a condition is illustrated in FIG. 3.

A POS terminal 100A comprises a system unit 50A, the printer 8, a battery unit 10A and a micro computer 9A. In FIG. 3, the units with symbols the same as symbols in FIG. 2 are units the same as the units in FIG. 2, and therefore, descriptions are omitted.

The system unit 50A comprises a terminal 61 connected with the micro computer 9A and the signal line. The battery unit 10A comprises a terminal 65 connected with the micro computer 9A and an electricity supply line, and a terminal 66 connected with the signal line. The micro computer 9A comprises terminals 62, 63 and 64. The terminal 62 is connected with the terminal 61 of the system unit 50A, the terminal 63 is connected with the terminal 65 of the battery unit 10A, and the terminal 64 is connected with the terminal 66 of the battery unit 10A.

The micro computer 9A can be detachably mounted to the POS terminal 100A and the case of the battery unit 10A by connecting or taking down each terminal. In the condition of the state in which the micro computer 9A is taken down, of course, the batteries 11-14 cannot be monitored. In such a condition, the batteries 11-14 mounted on the battery unit 10A will supply the electricity to the system unit 50A and the printer 8 only. By connecting the micro computer 9A to the system unit 50A and the battery unit 10A, the micro computer 9A monitors the batteries 11-14. By the connection of the terminals 64 and 66, the micro computer 9A monitors the batteries 11-14. In addition, the terminals 64 and 66 form the terminals which can be connected by using four signal lines, so that the four batteries 11-14 can be monitored respectively. In addition, in the condition that the error is generated or in the condition that an inquiry is given out from the processor 1, the micro computer 9A notifies the error and the inquiry to the processor 1 by the connection between the terminals 61 and 62. By the connection of the terminals 63 and 65, the electricity supply to the micro computer 9A is carried out.

As shown in FIG. 2, by arranging the processor or the micro computer inside the POS terminal, the cheap battery of a non-smart battery can be also monitored. In addition, as shown in FIG. 3, the micro computer can be assembled and disassembled, and it can be set as an equipment configuration according with the needs of the user.

As described in detail above, according to the technology recorded herein, the expense when the POS terminal receiving the electricity from the battery runs can be restrained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A POS terminal, comprising:
a system unit;
a battery unit configured to accommodate a plurality of batteries; and
a monitoring unit configured to individually monitor the state of each battery accommodated and mounted in the battery unit and notify the state of the battery to the system unit.

2. The POS terminal according to claim 1, wherein
the monitoring unit is positioned at the outside of a case of the battery.

3. The POS terminal according to claim 1, wherein
the monitoring unit includes a terminal connected with the system unit and the battery unit, and the monitoring unit is detachably mounted to the system unit and the battery unit.

4. The POS terminal according to claim 1, further comprising:
a printer unit, wherein
at least one of the plurality of batteries supplies electricity to the printer unit, and the other batteries supply the electricity to the units except the printer unit.

5. A POS terminal, comprising:
a system unit;
a battery unit configured to accommodate a battery; and
a monitoring unit configured to individually monitor the state of the battery accommodated and mounted in the battery unit, notify the state of the battery to the system unit, and be positioned at the outside of a case of the battery.

6. The POS terminal according to claim 5, wherein
the monitoring unit includes a terminal connected with the system unit and the battery unit, and the monitoring unit is detachably mounted to the system unit and the battery unit.
